(19) United States
(12) Patent Application Publication
(10) Pub. No.: US 2016/0241770 A1
(43) Pub. Date: Aug. 18, 2016

(54) IP CAMERA AND VIDEO PLAYBACK METHOD THEREOF

(71) Applicant: TriClouds Corporation, Hsinchu City (TW)

(72) Inventors: CHIEN-HUA SU, Taipei City (TW); WEN-RUEI CHEN, Hsinchu City (TW); MENG-CHENG YU, Hsinchu City (TW); MING-CHIH CHANG, Hsinchu County (TW)

(21) Appl. No.: 14/716,447

(22) Filed: May 19, 2015

(30) Foreign Application Priority Data
Feb. 17, 2015 (TW) 104105569

(51) Int. Cl. H04N 5/232; H04L 12/875; G06K 9/46; H04N 7/18; G06K 9/60; H04L 29/06; H04L 12/801

(52) U.S. Cl. CPC H04N 5/23206; H04L 65/602; H04L 65/4069; H04L 47/56; H04L 47/115; H04N 7/181; G06K 9/60; G06K 9/46

(57) ABSTRACT

Disclosed is an IP camera and a video playback method thereof, the IP camera connected to a host through the network, the IP camera includes an image capturing unit, a processor, and an input/output buffer unit. An external video is captured by the image capturing unit, and the external video includes a plurality of frames. An image outputting rate is determined by the processor, and an output external image is produced by reducing a resolution of the external image and remarking a confirm flag in at least one first frame when an image output rate is lower than a threshold value. The external image or the processed image is inputted to the I/O buffer unit to form an output external image. By way of the present invention, the captured video may still be watched instantly and fluently on the host while the host is suffering from the network congestion.

### CROSS-REFERENCE TO RELATED APPLICATION

This application claims priority from Taiwan Patent Application No. 104105569, filed on Feb. 17, 2015, in Taiwan Intellectual Property Office, the contents of which are hereby incorporated by reference in their entirety for all purposes.

### BACKGROUND OF THE INVENTION

1. Field of the Invention

The exemplary embodiment(s) of the present invention described hereinafter relates to an IP camera, more specifically, the exemplary embodiment(s) of the present invention relates to a video playback method thereof with automatically detecting the quality of the output image and accordingly performing improvements thereon.

2. Description of the Related Art

IP camera is an apparatus includes a camera, a video compression chip, and a computer, and the computer therein is a micro-computer designed for network application function. Each IP cameras has its own IP network address, and can be connected to the network as a network equipment. The IP camera also includes built-in software acting as web-servers, FTP servers, FTP clients, and E-mail clients.

While the captured video is transmitted by the IP camera through the network, network congestion usually happens under the environment of wired/wireless network, which is inconvenient for users who desire for real-time video. In prior arts, the reduction of the resolution of the video may be utilized to solve the problem, however, it may also cause the problem of blurring image.

Hence, it is a primary issue to give consideration to both the fluency and the clarity of the picture quality while the IP cameras are streaming videos via the network.

### SUMMARY OF THE INVENTION

To solve the problems in the conventional arts, a primary objective of the present invention is to provide an IP camera and a video playback method thereof to solve the fluency problem happens while the IP camera is playing in real-time through the network.

To solve the problems in the conventional arts, it is a primary objective of the present invention to provide an IP camera and a video playback method thereof to solve the clarity problem that happens while the IP camera is playing in real-time through the network.

To achieve the above object, the present invention provides a video playback method applicable to an IP camera and a host interconnected through the network. The IP camera includes a processor, an image capturing unit and an input/output (I/O) buffer unit. The video playback method includes using the image capturing unit to capture an external video of an external environment, and the external video includes a plurality of frames; using the processor to determine an video output rate between the IP camera and the host; generating a processed video by using the processor to reduce a resolution of the external video and to remark a confirm flag in at least one first frame of the plurality of the frames according to a feature point in the at least one first frame while the video output rate is lower than a threshold value; and inputting the external video or the processed video to the I/O buffer unit as an output external video to be transferred to the host.

Preferably, the host may transmit a receiving confirm packet to the processor when the host receives the at least one first frame.

Preferably, the video playback method may further include a step of using the processor to merely transmit the at least one first frame among the plurality of the frames when the processor does not receive the receiving confirm packet beyond an expiration time.

Preferably, the processor may be configured to search the at least one first frame having the feature point by performing an image identification process, and the confirm flag is added to the at least one first frame.

Preferably, the feature point may include a face of person, a license plate, text, and an image of a vehicle, or any combination thereof.

To achieve another objective, the present invention further provides an IP camera connected to a host through the network. The IP camera includes an image capturing unit, a processor, and an input/output buffer unit. An external video of an external environment is captured by the image capturing unit and includes a plurality of frames, an video output rate between the IP camera and the host is determined by the processor. A processed video is generated by the processor by reducing a resolution of the external video and remarking a confirm flag in at least one first frame of the plurality of the frames according to a feature point in the at least one first frame while the video output rate is lower than a threshold value, and the external video or the processed video is inputted to the I/O buffer unit to generate an output external video to be transferred to the host.

Preferably, the host may transmit a receiving confirm packet to the processor when the host receives the at least one first frame.

Preferably, the processor may merely transmit the at least one first frame of the plurality of the frames when the processor does not receive the receiving confirm package beyond an expiration time.

Preferably, the processor may further search the at least one first frame having a feature point by performing an image identification process, and the confirm flag is added into the at least one first frame.

Preferably, the feature point may include a face of a person, a license plate, text, an image of a vehicle, or any combination thereof.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of an IP camera according to the present invention.

FIG. 2A is a first schematic diagram according to the IP camera of the present invention.

FIG. 2B is a second schematic diagram according to the IP camera of the present invention

FIG. 3 is a flow chart according to the video playback method for IP cameras of the present invention.

### DESCRIPTION OF THE PREFERRED EMBODIMENTS

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

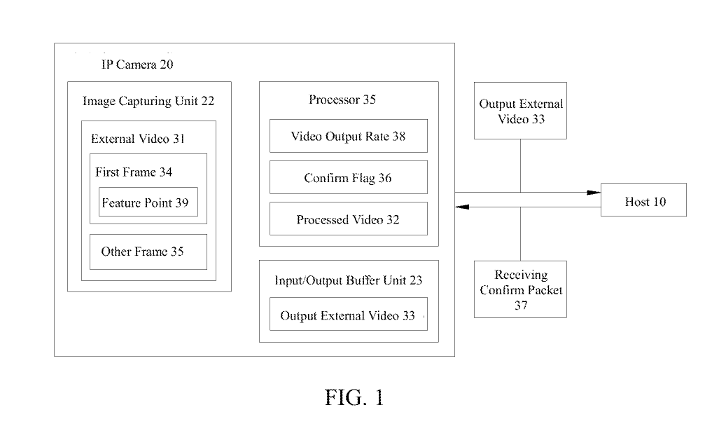

Please refer to FIG. 1, which illustrates a block diagram of an IP camera according to the present invention. The IP camera 20 of the present invention is connected to a host 10 through a cable network or a wireless network. The IP camera 20 includes an image capturing unit 22, a processor 21, and an input/output (I/O) buffer unit 23. The host 10 may include a computer host, a server, or a notebook, the image capturing unit 22 includes a lens, the processor 21 includes a micro-processor or a central process unit, and the I/O buffer unit 23 includes a physical memory or a cache memory.

The image capturing unit 22 may be used for capturing an external video 31 of an external environment, and the external video 31 may include a plurality of frames 35. The I/O buffer unit 23 may be used for inputting the external video 31 or a processed video 32 to generate an output external video 33, such that the output external video 33 may be transmitted to the host 10.

The processor 21 may be used for determining an video output rate 38 of the above-described I/O buffer unit 23, when the video output rate 38 is lower than a threshold value, the processor 21 reduces a resolution of the external video 31 and remarking a confirm flag 36 in at least one first frame 34 of the plurality of frames 35 to generate the processed video 32. Here, the video output rate 38 is the transmission speed of the output external video 33 from the IP camera 20 to the host 10, and may be determined according to the network speed and the network bandwidth between the IP camera 20 and the host 10.

Furthermore, the processor 21 may perform a video identification process on the at least one first frame 34 in order to confirm whether a feature point 39 is existed in the at least one first frame 34, if “yes”, a confirm flag 36 is added into the at least one first frame 34 and the first frame 34 is inputted to the I/O buffer unit 23 by the processor 21.

When the host 10 receives the first frame 34, a receiving confirm packet 37 is transmitted back to the processor 21 to ensure the first frame 34 is transmitted to the host 10. When the processor 21 does not receive the receiving confirm packet 27 beyond an expiration period, the processor 21 merely transmits the at least one first frame 34 of the plurality of the frames 35 again, and the feature point 39 in the first frame 34 may be more important or more interesting part of video regarded by the users, such as a face of a person, a license plate of a vehicle, texts, a figure, etc. By this way, after a period of time, a total file size of the processed video 32 inputted to the I/O buffer unit 23 by the processor 21 will be decreased gradually, and the output external video 33 received by the host 10 will be a continuous video with fluency and having the feature point 39.

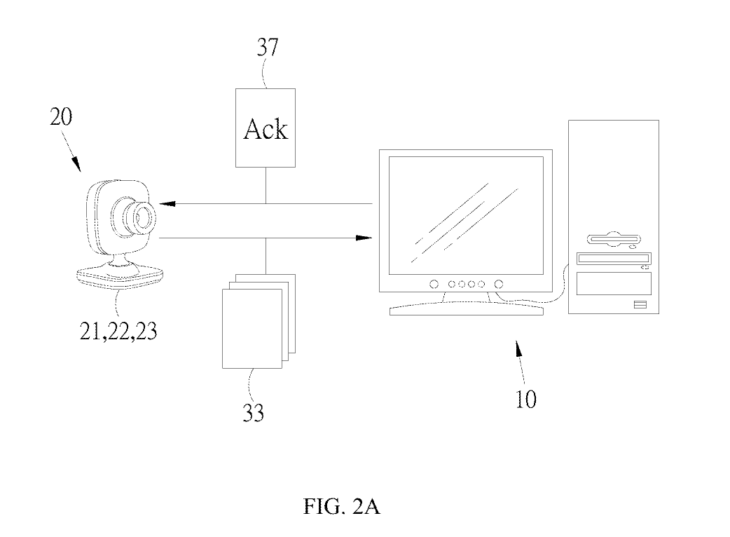

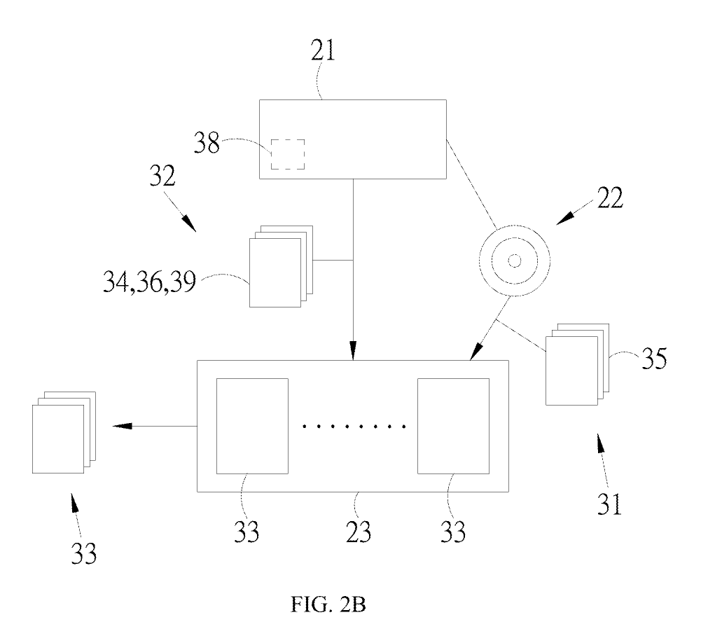

Please refer to FIG. 2A and FIG. 2B, which illustrate a first and a second schematic drawing according to the IP camera of the present invention, respectively. In FIG. 2A, an output external video 33 is transmitted to a host 10 by a IP camera 20 through a network. The IP camera 20 includes a processor 21, an image capturing unit 22, and an input/output (I/O) buffer unit 23. In the embodiment, the captured external video 31 is continuously inputted to the I/O buffer unit 23 by the image capturing unit 22 of the IP camera 20, and when the network is overloaded by an excessive number of packets, or the host 10 is busy, delays or stagnations of the video transmitted to the host 10 from the IP camera 20 will occur due to the network congestion.

When the video output rate 38 is determined to be lower than a threshold value by the processor 21, the captured external video 31 may be divided into a first frame 34 and other frame 35 by the processor 21, and the first frame may be an I-Frame, and the other frame 35 may be a P-Frame or a B-Frame. The first frame 34 includes at least one feature point 39, such a face signature of a person, texts, numbers, or lines, etc., that is to say, the first frame 34 is a part of the video must be presented clearly on the host 10, and the other frame 35 may be presented on the host 10 by using the way of image compensations or other image processing methods.

A confirm flag 36 may be added to the first frame 34 to generate a processed video by the processor 21, and the processed video 32 is inputted into the I/O buffer unit 23. The other frame 35 may be inputted into the I/O buffer unit 23 directly or be inputted after a resolution of the other frame 35 is reduced. Here, the video inputted into the I/O buffer unit 23 is denoted as an output external video 33 for clarity, and the output external video 33 is transmitted to the host 10 through the network.

As shown in FIG. 2A, after the first frame 34 in the output external video 33 is received by the host 10, a receiving confirm packet 37 is transmitted back to the processor 21. If the receiving confirm packet 37 is not received by the processor 21 within a predetermined time period, the first frame 34 is transmitted to the host 10 again. Note that the previous transmitted other frame 35 will not be transmitted again along with the first frame in the later transmission.

Thus, the video content of the first frame 34 may be clearly received continuously by the host 10, and the other frame 35 may be obtained compensatorily by using a decoding method of general image processing method, such that the problem of network congestion may be improved, that is, the real-time video transmitted from the IP camera 20 may be received fluently by the host 10.

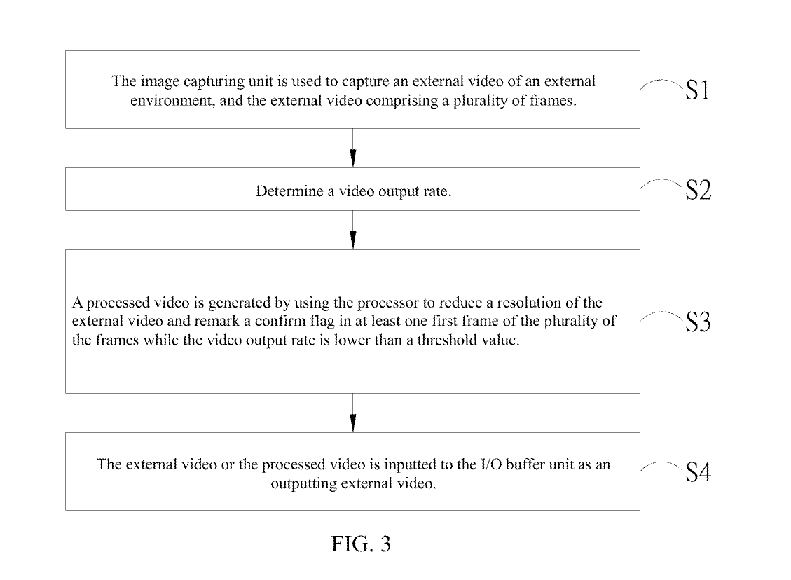

Please refer to FIG. 3, which illustrates a flow chart according to the video playback method for IP cameras of the present invention. The video playback method is applicable to an IP camera and a host interconnected through network. The IP camera includes a processor, an image capturing unit and an input/output (I/O) buffer unit, and the video playback method includes following steps.

Step S1: Using the image capturing unit to capture an external video of an external environment, and the external video comprising a plurality of frames.

Step S2: Using the processor to determine a video output rate.

Step S3: Generating a processed video by using the processor to reduce a resolution of the external video and remarking a confirm flag in at least one first frame of the plurality of the frames while the video output rate is lower than a threshold value.

Step S4: Inputting the external video or the processed video to the I/O buffer unit as an output external video.

From the above, the IP camera and the video playback method disclose a scheme for generating a processed video by utilizing the reduction of the resolution or addition of the confirm flag, and the method may be utilized to solve problems of the fluency and the clarity while the IP cameras are real-time broadcasting via the network during the network is suffering from network congestion.

In accordance with the embodiment(s) of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A video playback method applicable to an IP camera and a host interconnected through network, the IP camera comprising a processor, an image capturing unit and an input/output (I/O) buffer unit, the video playback method comprising following steps:
using the image capturing unit to capture an external video of an external environment, and the external video comprising a plurality of frames;
using the processor to determine an video output rate between the IP camera and the host;
generating a processed video by using the processor to reduce a resolution of the external video and to remark a confirm flag in at least one first frame of the plurality of the frames according to a feature point in the at least one first frame while the video output rate is lower than a threshold value; and
inputting the external video or the processed video to the I/O buffer unit as an output external video to be transferred to the host.

2. The video playback method as claimed in claim 1, wherein the host transmits a receiving confirm packet to the processor when the host receives the at least one first frame.

3. The video playback method as claimed in claim 2, further comprising a step of using the processor to merely transmit the at least one first frame of the plurality of the frames when the processor does not receive the receiving confirm packet beyond an expiration time.

4. The video playback method as claimed in claim 1, wherein the processor is configured to search the at least one first frame having the feature point by performing an image identification process, and the receiving confirm flag is added to the at least one first frame.

5. The video playback method as claimed in claim 4, wherein the feature point comprises a face of person, a license plate, text, an image of a vehicle, or any combination thereof.

6. An IP camera connected to a host through a network, the IP camera comprising:
an image capturing unit;
a processor connected to the image capturing unit; and
an input/output (I/O) buffer unit connected to the processor, wherein an external video of an external environment is captured by the image capturing unit and comprises a plurality of frames, an video output rate between the IP camera and the host is determined by the processor, a processed video is generated by the processor by reducing a resolution of the external video and remarking a confirm flag in at least one first frame of the plurality of the frames according to a feature point in the at least one first frame while the video output rate is lower than a threshold value, and the external video or the processed video is inputted to the I/O buffer unit to generate an output external video to be transferred to the host.

7. The IP camera as claimed in claim 6, wherein the host transmits a receiving confirm packet to the processor when the host receives the at least one first frame.

8. The IP camera as claimed in claim 7, wherein the processor merely transmits the at least one first frame of the plurality of the frames when the processor does not receive the receiving confirm package beyond an expiration time.

9. The IP camera as claimed in claim 6, wherein the processor further searches the at least one first frame having the feature point by performing an image identification process, and the confirm flag is added into the at least one first frame.

10. The IP camera as claimed in claim 9, wherein the feature point comprises a face of a person, a license plate, text, an image of a vehicle, or any combination thereof.
